(19) United States
(12) Patent Application Publication
(10) Pub. No.: US 2018/0220156 A1
(43) Pub. Date: Aug. 2, 2018

(54) METHOD AND DEVICE FOR CORRECTING DISTORTION OF PANORAMIC VIDEO

(71) Applicant: KT CORPORATION, Gyeonggi-do (KR)

(72) Inventor: I Gil KIM, Seoul (KR)

(73) Assignee: KT CORPORATION, Gyeonggi-do (KR)

(21) Appl. No.: 15/742,403

(22) PCT Filed: Jul. 7, 2016
(86) PCT No.: PCT/KR2016/007352

§ 371 Date: Jan. 5, 2018

(30) Foreign Application Priority Data
Jul. 8, 2015 (KR) 10-2015-0097007
Sep. 14, 2015 (KR) 10-2015-0129819
Oct. 1, 2015 (KR) 10-2015-0138631

(51) Int. Cl. H04N 19/597; H04N 5/232; G06T 3/00; H04N 19/136; H04N 19/174

(52) U.S. Cl. CPC H04N 19/597; H04N 5/23238; H04N 19/174; H04N 19/136; G06T 3/0093

(57) ABSTRACT

Disclosed is a method of encoding a panoramic video. The method includes dividing an input image into a plurality of segments, determining whether each of the segments is a warped region or an un-warped region, performing de-warping on a segment determined as being the warped region, based on a panoramic format associated with the input image, and encoding the de-warped segment.

### TECHNICAL FIELD

The present invention relates to a method and device for correcting distortions in a panoramic video.

### BACKGROUND ART

Recently, the demand for high-resolution quality images such as high definition (HD) images or ultra high definition (UHD) images has increased in various application fields. However, higher resolution and quality image data accompanies an increase in a data amount in comparison with conventional image data. Therefore, when transmitting image data by using a medium such as conventional wired or wireless broadband networks or when storing image data in a conventional storage medium, transmission cost and storage cost increase. In order to solve these problems occurring with an improvement in resolution and quality of image data, high-efficiency image compression techniques are required.

Image compression technology includes various techniques, including: an inter-prediction technique of predicting a pixel value included in a current picture from a previous or subsequent picture of the current picture; an intra-prediction technique of predicting a pixel value included in a current picture by using pixel information in the current picture; an entropy encoding technique of assigning a short code to a value with a high appearance frequency and assigning a long code to a value with a low appearance frequency; etc. Image data can be effectively compressed by using such image compression technology, and can be transmitted or stored.

Meanwhile, along with the increase in the demand for high resolution images, the demand for the content of stereoscopic images has also increased, leading to emerging of a new image providing service. Discussions about a video compression technology are taking place to effectively provide a stereoscopic image content containing HD or UHD images.

### DISCLOSURE

### Technical Problem

An objective of the present invention is to lower a computing load for distortion correction and to overcome difficulties in providing a versatile terminal service to respond to a diversity of panoramic camera forms.

Another objective of the present invention is to enable processing of panoramic videos of a diversity of formats by creating a database of distortion information of each panoramic camera and by using a clouding computing process to provide a versatile panoramic video playback service.

### Technical Solution

The present invention provides a panoramic video encoding method including: dividing an input image into a plurality of segments; determining whether the plurality of segments each are a warped region or an un-warped region, segment by segment; performing de-warping on a segment determined as being the warped region, based on a panoramic format associated with the input image; and encoding the segment having undergone the de-warping.

In the panoramic video encoding method according to the present invention, the determining may be performed based on at least one of the number of vertices and a shape of a warping mesh within the segment.

In the panoramic video encoding method according to the present invention, the panoramic format may mean a warping type or a distortion pattern associated with the input image.

In the panoramic video encoding method according to the present invention, the performing de-warping may include determining the panoramic format to be used in the de-warping, based on camera identification information associated with the input image.

In the panoramic video encoding method according to the present invention, the camera identification information may mean signaled information used to identify a type or a characteristic of a camera used to take the input image.

In the panoramic video encoding method according to the present invention, the performing de-warping may include: determining a camera type used to take the input image based on the camera identification information; and derive the panoramic format corresponding the determined camera type from predefined table information.

In the panoramic video encoding method according to the present invention, the table information includes available panoramic formats for each camera type.

In the panoramic video encoding method according to the present invention, the segment may include a plurality of largest coding unit (LCU) rows, the segment may undergo parallel de-warping, LCU row by LCU row, and a plurality of LCUs within the same LCU row sequentially undergoes the de-warping, LCU by LCU, in a predefined scanning order.

The present invention provides a panoramic video encoding device including: a warped region determination module configured to divide an input image into a plurality of segments and to determine whether the plurality of segments each is a warped region or an un-warped region, segment by segment; a de-warping module configured to perform de-warping on a segment determined as being the warped, based on a panoramic format associated with the input image; and an encoder configured to encode the segment having undergone the de-warping.

In the panoramic video encoding device according to the present invention, the warped region determination module may determine whether each of the segments is a warped region or an un-warped region based on at least one of the number of vertices and a shape of a warping mesh within the corresponding segment.

In the panoramic video encoding device according to the present invention, the panoramic format may mean a warping type or a distortion pattern associated with the input image.

In the panoramic video encoding device according to the present invention, the de-warping module may determine the panoramic format, based on camera identification information associated with the input image.

In the panoramic video encoding device according to the present invention, the camera identification information may mean signaled information to identify a type or a characteristic of a camera used to take the input image.

In the panoramic video encoding device according to the present invention, the de-warping module may determine a camera type used to take the input image, based on the camera identification information and derive the panoramic format corresponding to the determined camera type from predefined table information.

In the panoramic video encoding device according to the present invention, the table information may include available panoramic formats for each camera type.

In the panoramic video encoding device according to the present invention, the segment may include a plurality of largest coding unit (LCU) rows and the de-warping module may perform parallel de-warping on the LCU rows included in the segment, LCU row by LCU row, in which LCUs included in the same LCU row may sequentially undergo the de-warping, LCU by LCU, in a predefined scanning order.

The present invention provides a panoramic video encoding system including: a panoramic image processing server configured to determine whether each of a plurality of segments constituting a panoramic video is a warped region or an un-warped region, to perform de-warping on a segment determined as being the warped region, based on a panoramic format associated with the panoramic video, and to encode the segment having undergone the de-warping; and a database server configured to determine a panoramic format corresponding to the panoramic video.

In the panoramic video encoding system according to the present invention, the database server may determine a panoramic format to be used for the de-warping of the panoramic video, based on camera identification information associated with the panoramic video and inform the panoramic image processing server of the determined panoramic format.

In the panoramic video encoding system according to the present invention, the database server may determine a camera type used to take the panoramic video, based on the camera identification information and derive a panoramic format corresponding to the determined camera type from predefined table information.

In the panoramic video encoding system according to the present invention, the table information may include available panoramic formats for each camera type.

### Advantageous Effects

It is possible to lower a computing load for distortion correction by dividing an input image into a predetermined number of segments and performing the distortion correction on the input image, segment by segment, thereby enabling a high resolution panoramic video to be processed even in a terminal with a relatively low computing power.

A server-client-based hybrid distortion correction method provides a versatile panoramic video playback service by using clouding computing such that low-spec terminals as well as high-spec terminals can play all formats of panoramic videos taken by all types of cameras.

### DESCRIPTION OF DRAWINGS

FIG. 1 is an application example of the present invention and illustrates a process of reconstructing a user-view image through de-warping;

FIG. 2 is an application example of the present invention and illustrates a de-warping process based on parallel processing;

FIG. 3 is an application example of the present invention and illustrates a method of determining whether a region in an image is a warped region or an un-warped region, segment by segment;

FIG. 4 is an application example of the present invention and illustrates the schematic construction of a panoramic image processing server 100;

FIG. 5 is a block diagram schematically illustrating an encoder 400 according to one embodiment of the present invention;

FIG. 6 is an application example of the present invention and illustrates a system for performing de-warping based on computing power;

FIG. 7 is an application example of the present invention and illustrates a method of performing selective de-warping by a panoramic image processing server 100 or a terminal 10, depending on performance of a terminal;

FIG. 8 is an application example of the present invention and illustrates a process of performing de-warping on a warped image based on quad-tree structure partitioning;

FIG. 9 is an application example of the present invention and illustrates a method of partitioning a segment based on quad-tree structure partitioning; and

FIG. 10 is an application example of the present invention and illustrates types of a panoramic format.

### BEST MODE

A panoramic video encoding method according to the present invention includes dividing an input image into a plurality of segments, determining whether each segment is a warped region or an un-warped region, performing de-warping on a segment determined as being the warped region, based on a panoramic format associated with the input image, and encoding the segment having undergone the de-warping.

In the panoramic video encoding method according to the present invention, whether a certain segment is a warped region or an un-warped region is determined based on at least one of the number of vertices and a shape of a warping mesh within the segment.

In the panoramic video encoding method according the present invention, the panoramic format may mean a warping type or an image distortion pattern associated with the input image.

In the panoramic video encoding method according to the present invention, the performing de-warping includes determining the panoramic format based on camera identification information associated with the input image.

In the panoramic video encoding method according to the present invention, the camera identification information may mean signaled information to identify a type or a characteristic of a camera used to take the input image.

In the panoramic video encoding method according the present invention, the performing de-warping includes: determining a type of a camera used to take the input image, based on the camera identification information; and deriving the panoramic format corresponding to the determined camera type from predetermined table information.

In the panoramic video encoding method according to the present invention, the table information may include available panoramic formats for each camera type.

In the panoramic video encoding method according to the present invention, the segment may include a plurality of largest coding unit (LCU) rows, the segment may undergo parallel de-warping, LCU row by LCU row, and LCUs in the same LCU row may sequentially undergo the de-warping, LCU by LCU, in a predetermined scanning order.

A panoramic video encoding device according to the present invention includes a warped region determination module configured to divide an input image into a plurality of segments and to determine whether each segment of the plurality of segments is a warped region or an un-warped region, a de-warping module configured to perform de-warping on a segment determined as being the warped region, based on a panoramic format associated with the input image, and an encoder configured to encode the segment having undergone the de-warping.

In the panoramic video encoding device according to the present invention, the warped region determination module may determine whether each of the segments is a warped region or an un-warped region based on at least one of the number of vertices and a shape of a warping mesh within the corresponding segment.

In the panoramic video encoding device according to the present invention, the panoramic format may mean a warping type or a distortion pattern associated with the input image.

In the panoramic video encoding device according to the present invention, the de-warping module may determine the panoramic format associated with the input image based on camera identification information.

In the panoramic video encoding device according to the present invention, the camera identification information may mean signaled information to identify a type or a characteristic of a camera used to take the input image.

In the panoramic video encoding device according to the present invention, the de-warping module may determine the type of the camera used to take the input image based on the camera identification information and derive the panoramic format corresponding to the determined camera type from predefined table information.

In the panoramic video encoding device according to the present invention, the table information may include available panoramic formats for each camera type.

In the panoramic video encoding device according to the present invention, the segment may include a plurality of largest coding unit (LCU) rows and the de-warping module may perform parallel de-warping on the segment, LCU row by LCU row, in which LCUs within the same LCU row may sequentially undergo the de-warping, LCU by LCU, in a predefined scanning order.

A panoramic video encoding system according to the present invention includes: a panoramic image processing server configured to determine whether each segment of a plurality of segments constituting a panoramic video is a warped region or an un-warped region, to perform de-warping on a segment determined as being the warped region, based on a panoramic format associated with the panoramic video, and to encode the segment having undergone the de-warping; and a database server configured to determine a panoramic format corresponding to the panoramic video.

In the panoramic video encoding system according to the present invention, the database server may determine a panoramic format used for the de-warping of the panoramic video, based on camera identification information of the panoramic video, and inform the panoramic image processing server of the determined panoramic format.

In the panoramic video encoding system according to the present invention, the database server may determine a type of a camera used to take the panoramic video based on the camera identification information and derive a panoramic format corresponding to the determined camera type from predefined table information.

In the panoramic video encoding system according to the present invention, the table information includes available panoramic formats for each camera type.

### Mode for Invention

Hereinafter, preferred embodiments of the present invention will be described with reference to the accompanying drawings. Further, it should be noted that the terms and words used in the specification and the claims should not be construed as being limited to ordinary meanings or dictionary definitions, but should be interpreted as having meanings that are consistent with their meanings in the context of the relevant art and the technical spirit of the present invention based on the principle that the inventors can appropriately define the terms to best describe their invention. Meanwhile, the embodiments described in the specification and the configurations illustrated in the drawings are merely examples and do not exhaustively present the technical spirit of the present invention. Accordingly, it should be appreciated that there may be various equivalents and modifications that can replace the embodiments and the configurations at the time at which the present application is filed.

In the present disclosure, it will be understood that when an element is referred to as being “coupled” or “connected” to another element, it can be directly coupled or connected to the other element or intervening elements may be present therebetween. It will be further understood that the terms “comprise”, “include”, “have”, etc. when used in the present disclosure specify the presence of stated features, integers, steps, operations, elements, components, and/or combinations thereof but do not preclude the presence or addition of one or more other features, integers, steps, operations, elements, components, and/or combinations thereof.

It will be understood that, although the terms first, second, etc. may be used herein to describe various elements, these elements should not be limited by these terms. These terms are only used to distinguish one element from another element and not used to show order or priority among elements. For instance, a first element discussed below could be termed a second element without departing from the teachings of the present invention. Similarly, the second element could also be termed the first element

In addition, in the embodiments of the present invention, distinguished elements are termed to clearly describe features of various elements and do not mean that the elements are physically separated hardware units or software pieces. That is, although a plurality of distinguished elements is enumerated for convenience of a description, two or more elements may be combined into a single element, and conversely one element may be divided into a plurality of elements when performing a specific function, and embodiments of a combined form and a divided form also fall within the scope of the present invention as long as they do not depart from the essence of the present invention.

In addition, some of the constituent elements may not be essential elements of the present invention but may be optional elements provided for a simple performance improvement. The present invention may be embodied by including only essential elements while excluding optional elements. Therefore, a structure including only essential elements and excluding optional elements provided for a simple performance improvement also may fall within the scope of the present invention.

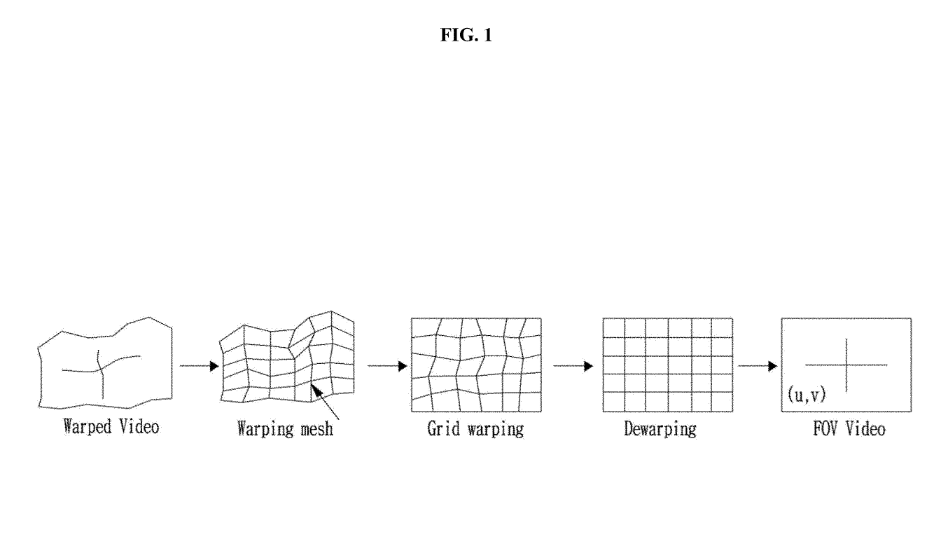

FIG. 1 is an application example of the present invention and illustrates a process of reconstructing a user-view image through de-warping.

A panoramic video captured by a camera is likely to be distorted as shown in FIG. 1. Hereinafter, a distorted panoramic video will be referred to as a warped image.

A warping mesh corresponding to a warped image may be determined. The warping mesh may be determined based on a camera type, a panoramic format type, a camera parameter, etc. Camera parameters are categorized into intrinsic camera parameters and extrinsic camera parameters. The intrinsic camera parameters are a focal length, an aspect ratio, a principal point, etc. The extrinsic camera parameters are position information of a camera in a global coordinate system, etc.

A grid-warped image may be generated by performing grid warping on a warping mesh so as to fit a rectangular video screen.

The grid-warped image may include a region having distorted image information, and a user-view image may be reconstructed by correcting the distorted image information. Hereinafter, the process of correcting distorted image information will be referred to as de-warping.

The reconstructed image may be divided into a plurality of predetermined units (for example, slices, tiles, coding blocks, prediction blocks, transform blocks, etc.) and the predetermined units of the reconstructed image may be sequentially subjected to prediction, transform, quantization, and entropy encoding. As a result, a bitstream is generated.

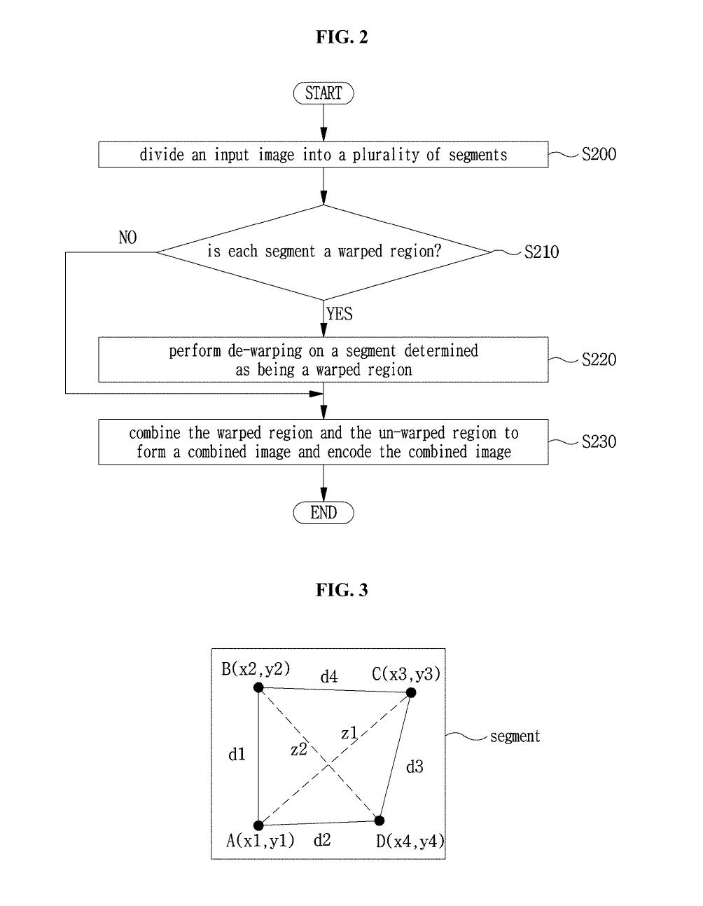

FIG. 2 is an application example of the present invention and illustrates a de-warping process based on parallel processing.

Referring to FIG. 2, an input image may be divided into a plurality of segments (Step S200).

The term “segment” may mean a predetermined unit defined for parallel processing of the input image. For example, the segment may mean a slice, a slice segment, or a tile. In the present invention, the term “parallel processing” means that a certain segment among the plurality of segments is encoded without dependency on another segment. That is, the term “parallel processing” means that a certain segment is independently encoded without referring to coding information used to encode another segment. Alternatively, the term “segment” may mean a basic unit (for example, a coding unit) for processing the input image.

In order to obtain optimum encoding efficiency, the number of segments constituting one input image may be appropriately determined. In addition, whether or not each segment has an identical size may be determined. When the segments do not have an identical size, the size of each segment may be determined. One input image may be divided into a plurality of segments based on at least one of the determined number of segments and the determined size of each segment.

Referring to FIG. 2, whether or not each segment is a warped region is determined segment by segment (Step S210).

Herein, the term “warped region” means a region required to undergo de-warping. That is, when a certain segment includes at least one coding block having distorted image information, the segment is determined as being the warped region.

In the present invention, the determination of whether a certain segment is a warped region or an un-warped region is made based on the number of vertices of a warping mesh included the segment, the shape of the warping mesh, the size of the warping mesh, etc. The determination method will be described below with reference to FIG. 3.

When a certain segment is determined as being a warped region, de-warping is performed on the segment (Step S220).

Specifically, the segment may include a plurality of largest coding units (LCUs), and the LCUs may sequentially undergo de-warping one after another in a predefined scanning order (for example, raster scan).

Alternatively, the segment may be divided into a plurality of LCU rows and may undergo parallel de-warping, LCU row by LCU row. For this parallel de-warping, a current LCU in a current LCU row may be de-warped after a left LCU, an above LCU, and an above-left LCU of the current LCU are de-warped.

When one input image includes a plurality of warped regions, segments corresponding to the warped regions may be de-warped independently or in parallel.

When a current segment in the input image is determined as being a warped region, the segment may be de-warped based on a panoramic format of the input image. Here, the panoramic format may mean a warping type or an image distortion pattern that is likely to occur in the input image. Depending on the type or the intrinsic characteristic of a camera used to take the input image, the input image is likely to have an eigen panoramic format. In order to determine a panoramic format occurring in the input image, table information that defines mapping or correlation between camera types and panoramic formats may be used. That is, the type of a camera used to take the input image may identified or determined first, and a panoramic format corresponding to the determined camera type may then be derived from the table information.

The camera type associated with the input image may be determined based on camera identification information. The camera identification information may mean encoded information used to identify the type or the attribute of a camera used to take a panoramic video. For example, the camera identification information may include at least one of a serial number of a camera or a camera parameter. As the camera parameter, there are intrinsic camera parameters and extrinsic camera parameters, as described above. The intrinsic camera parameters are focal length, aspect ratio, principal point, etc. and the extrinsic camera parameters are position information of a camera in a global coordinate system, etc. The camera identification information may be signaled as a bitstream along with an input image. When a certain segment is determined as being the un-warped region at Step S210, de-warping on the segment may be skipped.

Referring to FIG. 2, an input image may be reconstructed by combining regions that are de-warped at Step S220 and regions that are determined as being the un-warped regions at Step S210, and the reconstructed input image may be encoded (Step S230).

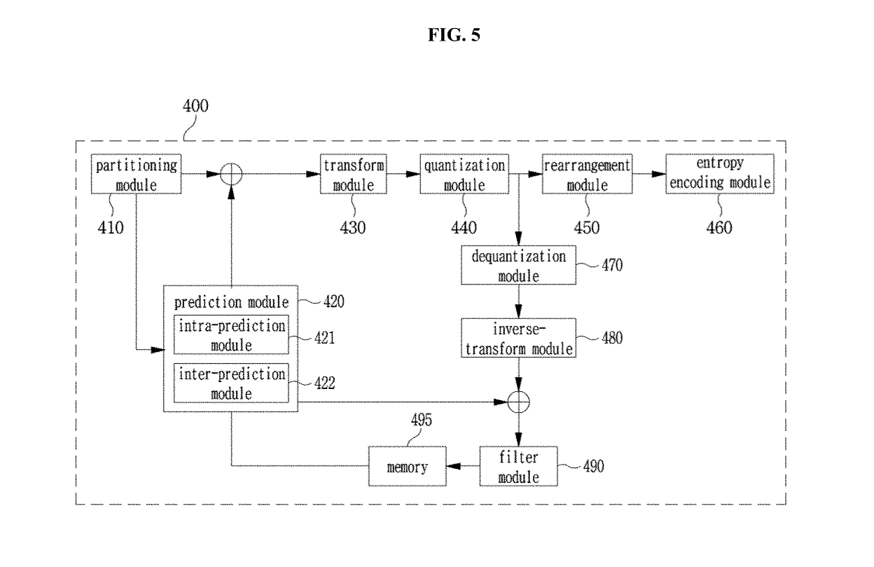

Specifically, prediction, transform, quantization, and entropy encoding may be performed on the reconstructed input image to generate a bitstream. This process will be described in detail below reference to FIG. 5.

FIG. 3 is an application example of the present invention and illustrates a method of determining whether a segment is a warped region or an un-warped region.

1. The Number of Vertices of a Warping Mesh

Whether a certain segment is a warped region or an un-warped region is determined based on the number of vertices of a warping mesh within the segment. In this determination process, the number of vertices of a warping mesh is compared with a first critical value. The first critical value may mean a minimum number of vertices at which de-warping on a segment can be skipped. The first critical value may be a preset value or may be a variable value that is set in accordance with external environmental conditions, such as a user or a camera.

For example, when the number of vertices of a warping mesh within a segment is less than four, the segment may be determined as being a warped region. Meanwhile, when the number of vertices of a warping mesh within a segment is four or more, the segment is determined as being an un-warped region and thus de-warping on the segment may be skipped.

2. The Shape of a Warping Mesh

Whether a certain segment is a warped region or an un-warped region may be determined based on the shape of a warping mesh within the segment. When the warping mesh within the segment has a square shape or a substantially square shape, the segment is determined as having a little distortion.

Referring to FIG. 3, when there is a warping mesh in which d1=d2 and z1=z2, the shape of the warping mesh is substantially square. Here, d1, d2, z1, z2 are determined according to the following formulas.

[Formula 1]

d1=\sqrt{(x2−x1)²−(y2−y1)²}

d2=\sqrt{(x4−x1)²−(y4-y1)²}

z1=\sqrt{(x3−x1)²−(y3−y1)²}

z2=\sqrt{(x4−x2)²−(y4−y2)²} [Formula 1]

In addition, whether a segment is a warped region or an un-warped region may be determined based on whether a difference value between the d1 and the d2 is less than a second critical value (first condition) and/or whether a difference value between the z1 and the z2 is less than a third critical value (second condition). The second critical value and the third critical value may mean maximum critical values at which de-warping on a segment can be skipped. The second and third critical values may be fixed values that are preset or variable values that can be set in accordance external environmental conditions, such as a panoramic video format, a user, a camera, etc.

For example, when the difference value between the d1 and the d2 is less than the second critical value and when the difference value between the z1 and the z2 is less than the third critical value, the segment is determined as being an un-warped region, so that de-warping on the segment may be skipped. Conversely, when the difference value between the d1 and the d2 is equal to or greater than the second critical value, or when the difference value between the z1 and the z2 is greater than the third critical value, the segment is determined as being a warped region, so that de-warping may be performed on the segment.

3. The Number of Vertices and the Shape of a Warping Mesh

Whether a certain segment is a warped region or an un-warped region may be determined in consideration of both of the number of vertices and the shape of a warping mesh within the segment.

Specifically, whether a certain segment is a warped region or an un-warped region may be determined by comparing the number of vertices of a warping mesh within the segment and the first critical value. When the number of vertices of a warping mesh is less than the first critical value, the segment may be determined as being a warped region. When the number of vertices of a warping mesh is greater than the first critical value, a determination of whether the segment is a warped region may be made again, depending on the shape of the warping mesh.

Referring to FIG. 3, when the difference value between the d1 and the d2 is less than the second critical value and the difference value between the z1 and the z2 is less than the third critical value, the segment is determined as being an un-warped region, and thus de-warping on the segment may be skipped. Conversely, when the difference value between the d1 and the d2 is greater than the second critical value or when the difference value between the z1 and the z2 is greater than the third critical value, the segment may be determined as being a warped region.

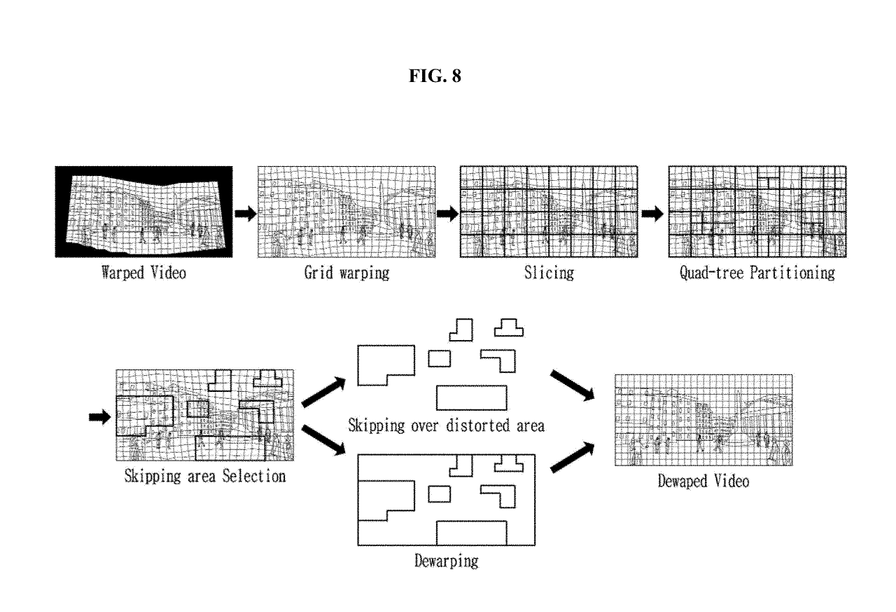

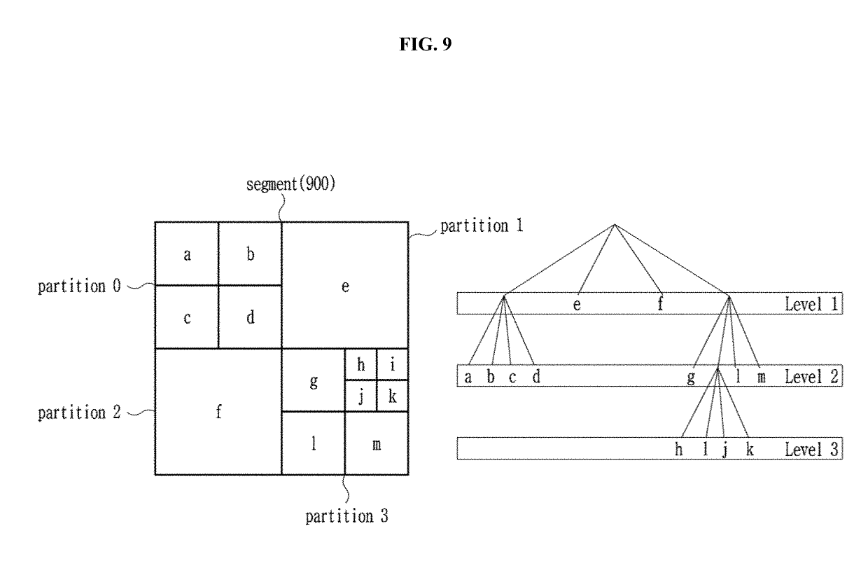

Although the method of determining whether each segment is a warped region or an un-warped region has been described above with reference to FIG. 3, the determination method is not limited thereto. For example, the determination of whether one segment is a warped region or an un-warped region may be performed by dividing one segment into a plurality of sub-segments that are smaller units than the segment and performing the determination, sub-segment by sub-segment. This method will be described in detail with reference to FIGS. 8 and 9.

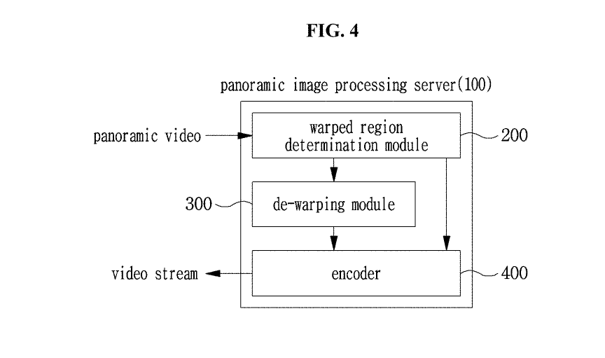

FIG. 4 is an application example of the present invention and illustrates the schematic construction of a panoramic image processing server 100.

According to the present invention, the panoramic image processing server 100 may include a warped region determination module 200, a de-warping module 300, and an encoder 400.

The warped region determination module 200 may divide an input image into a plurality of segments and perform a determination of whether the segments each are a warped region or an un-warped region, segment by segment.

The term “segment” may mean a predetermined unit that is predefined for parallel processing of the input image. For example, the segment may mean a slice, a slice segment, or a tile. The term “parallel processing” may mean that one segment among the plurality of segments is encoded without dependency on another segment. That is, the term “parallel processing” means that one segment is independently encoded without referring to coding information used to encode another segment.

In addition, the warped region determination module 200 may determine the number of segments constituting one input image to provide optimum encoding efficiency. In addition, the warped region determination module 200 may determine whether or not the segments have an identical size. When the segments do not have an identical size, the size of each segment may be determined. The input image may be divided into a certain number of segments based on at least one of the determined number of segments and the determined size of each segment.

In the present embodiment, the term “warped region” means a region required to undergo de-warping. That is, when a certain segment includes at least one coding block having distorted image information, the segment may be determined as being a warped region. The warped region determination module 200 determines whether a certain segment is a warped region in consideration of the number of vertices of a warping mesh within the segment, the shape of the warping mesh, or the size of the warping mesh. This method has been described above with reference to FIG. 3. Therefore, a further detailed description of the method will not be provided here.

When a certain segment is determined as being a warped region, the de-warping module 300 may perform de-warping on the segment.

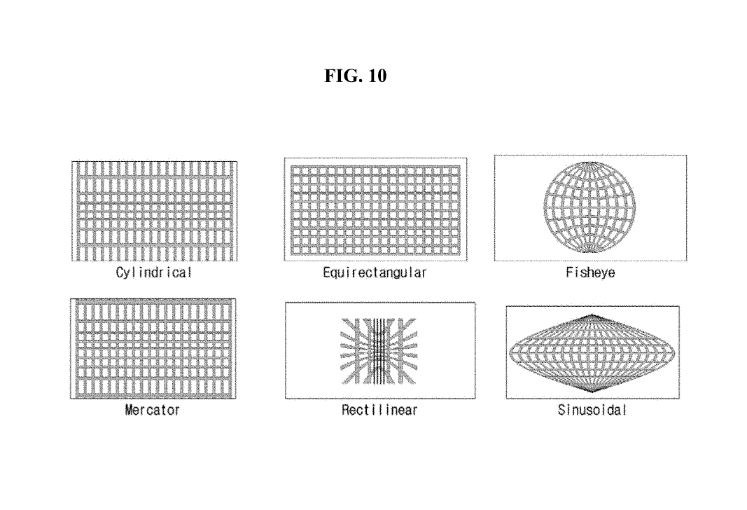

Specifically, the de-warping may be performed on the segment determined as being a warped region, based on a panoramic format of the panoramic video. The panoramic format may be a warping mesh or a warping mesh type occurring in the received panoramic video or may be an image distortion pattern that is likely to occur in a panoramic video. For example, FIG. 10 is an application example of the present invention and illustrates a variety of types of a panoramic format. Referring to FIG. 10, various types of panoramic formats including a cylindrical format, an equirectangular format, a fisheye format, a Mercator format, a rectilinear format, and a sinusoidal format may be used.

A panoramic video is likely to have a unique and/or general panoramic format depending on the type or the characteristic of a camera used to take the panoramic video. One or more panoramic formats among the various panoramic formats may be selectively used. To this end, a database server connected to the panoramic image processing server 100 through a wired or wireless network may be used.

The database server may store one or more panoramic formats that can be used for de-warping of a panoramic video. For example, the database server may store table information, such as Table 1, in which a mapping relationship or a correlation between camera types and panoramic formats are defined.

TABLE 1

| Camera type | Panoramic format |
|---|---|
| 1 | Cylindrical format |
| 2 | Fisheye format |
| 3 | Sinusoidal format |

Referring to Table 1, the table information shows camera types and panoramic formats corresponding to the respective camera types. That is, when a camera is categorized as Type 1, the camera uses a cylindrical panoramic format. When a camera is categorized as Type 2, the camera uses a fisheye panoramic format. Although Table 1 shows one-to-one matching between camera types and panoramic formats, one-to-many matching is also possible between camera types and panoramic formats. That is, one camera type may use a plurality of panoramic formats. That is, a database of distortion information that is generated when cameras take panoramic videos is constructed, and the distortion information may be adaptively used for panoramic videos having various formats.

The camera type means an index used to identify the type of a camera used to take a panoramic video, and the database server may use camera identification information to determine the type of a camera used to take a received panoramic video. The camera identification information may be transmitted as a bitstream along with the panoramic video. For example, the camera identification information may be signaled in a state in which it is included in a video parameter set, a sequence parameter set, or the like, or may be signaled as an SEI message.

The camera identification information may be encoded information used to determine the type or the attribute of a camera used to take a panoramic video. For example, the camera identification information may include at least one of a serial number of a camera and a camera parameter. Here, as described above, the camera parameters are categorized into intrinsic camera parameters and extrinsic camera parameters. The intrinsic camera parameters are focal length, aspect ratio, principal point, etc. The extrinsic camera parameters are position information of a camera in a global coordinate system.

The database server may identify and determine a camera type associated with a panoramic video based on the camera identification information and may derive a panoramic format corresponding to the determined camera type from predefined table information. The table information may not be limited to one stored in an external database server, but it may be one stored in a database provided in the panoramic image processing server 100.

When an input panoramic video needs to undergo de-warping, the panoramic image processing server 100 may request that the database server give thereto information on a panoramic format corresponding to the received panoramic video. In response to this request of the panoramic image processing server 100, the database server determines a panoramic format that can be used for de-warping of the received panoramic video through the determination process described above, and informs the panoramic image processing server 100 of the panoramic format. The de-warping module 300 of the panoramic image processing server 100 may perform de-warping on the corresponding segments of the received panoramic video based on the panoramic format determined by the database server.

The segment to undergo de-warping may include a plurality of largest coding units (LCUs), and the de-warping module 300 may perform de-warping on the segment, LCU by LCU, in a predefined scanning order (for example, raster scan).

Alternatively, the de-warping module 300 may divide the segment into a plurality of LCU rows, and the LCU rows of the segment may undergo parallel de-warping, row by row. For parallel processing, a current LCU in one LCU row may undergo de-warping after a left LCU, an above LCU, and an above-left LCU of the current LCU are de-warped.

When a plurality of warped regions exists within one input image, the de-warping module 300 may perform de-warping on the segments corresponding to the warped regions independently or in parallel. When a certain segment is determined as being an un-warped region by the warped region determination module 200, the segment may not be transmitted to the de-warping module 300 but be directly transmitted to the encoder 400 so as to be encoded by the encoder 400.

The encoder 400 may reconstruct an input image by combining the de-warped regions output from the de-warping module 300 and the un-warped regions output from the warped region determination module 200 and encode the reconstructed input image. That is, prediction, transform, quantization, and entropy encoding may be performed on the reconstructed input image to generate a bitstream. This encoding process will be described below with reference to FIG. 5.

FIG. 5 is a block diagram schematically illustrating the encoder 400 according to one embodiment of the present invention.

According to the present invention, the encoder 400 may include a partitioning module 410, a prediction module 420, a transform module 430, a quantization module 440, a rearrangement module 450, an entropy encoding module 460, a dequantization module 470, an inverse-transform module 480, a filter module 490, and a memory 495.

The encoder may be implemented by an image encoding method described in the embodiment of the present invention, and operation of some constituent elements may not be performed to lower the complexity of the encoder and to enable fast real-time encoding. For example, when the prediction module performs intra-prediction, a method of selecting an optimum intra-encoding mode from among all of the available intra-prediction modes for implementation of real-time encoding prediction is not used, but a method of selecting one intra-prediction mode from a limited number of intra-prediction modes as a final intra-prediction mode may be used. Alternatively, for example, when performing intra-prediction or inter-prediction, the shape of a prediction block that is used for the prediction may be limited.

The unit of a block processed by the encoder may be a coding unit that is a unit for performing encoding, a prediction unit that is a unit for performing prediction, or a transform unit that is a unit for performing transform. The unit for performing encoding may be termed a coding unit, the unit for performing prediction may be termed a prediction unit, and the unit for performing transform may be termed a transform unit.

The partitioning module 410 divides an input image into a plurality of sets of coding blocks, prediction blocks, and transform blocks, and divides an input image by selecting a predetermined set of a coding block, a prediction block, and a transform block according to a predetermined criterion (for example, a cost function). For example, in order to divide an input image into a plurality of coding units, a recursive tree structure such as quad-tree structure may be used. Herein below, in the embodiment of the present invention, the term “coding block” may mean a block to undergo decoding as well as a block to undergo encoding.

The term “prediction block” may be a unit by which prediction such as intra-prediction or inter-prediction is performed. A block to undergo intra-prediction may be a square block, such as a 2N×2N block or an N×N block. A block to undergo inter-prediction may be a square block such as a 2N×2N block or an N×N block, an oblong block such as a 2N×N block or an N×2N block, or an asymmetric format block generated by a prediction block partitioning method using asymmetric motion partitioning (AMP). Depending on the shape of the prediction block, a transform method performed by the transform module 415 may vary.

The prediction module 420 of the encoder 400 may include an intra-prediction module 421 for performing intra-prediction and an inter-prediction module 422 for performing inter-prediction.

The prediction module 420 may determine whether to perform intra-prediction or inter-prediction on a prediction block. When performing intra-prediction, a mode of intra-prediction may be determined for each prediction block, but a process of performing intra-prediction based on the determined intra-prediction mode may be performed on a transform block basis. A residual value (residual block) between a generated prediction block and an original block may be input to the transform module 430. In addition, prediction mode information, motion information, etc. used for the prediction may be encoded along with the residual value by the entropy encoding module 430 and may be transmitted to the decoder.

When a pulse coded modulation (PCM) encoding mode is used for encoding, the prediction may not be performed by the prediction module 420, but the original block may be directly transmitted to the decoder.

The intra-prediction module 421 may generate an intra-predicted prediction block based on reference pixels existing around a current block (block to be predicted). In the intra-prediction method, a directional prediction mode in which reference pixels are selected in a prediction direction and a non-directional prediction mode in which reference pixels are selected regardless of a prediction direction may be used, and a mode for predicting luma information and a mode for predicting chroma information may differ from each other. In order to predict chroma information, an intra-prediction mode used to predict luma information, or predicted luma information may be used. When there is no available reference pixel, the non-available reference pixels are replaced with other pixels, and a prediction block may be generated by using the replaced pixels.

The prediction block may include a plurality of transform blocks. At the time of performing intra-prediction, when the prediction block and the transform block have an equal size, the intra-prediction may be performed based on a left-hand pixel, an above-left pixel, and an above pixel of the prediction block. However, at the time of performing intra-prediction, when the prediction block and the transform block have different sizes and a plurality of transform blocks is included in the prediction block, the intra-prediction may be performed by using neighboring pixels adjacent to the transform block. Here, the neighboring pixels adjacent to the transform block may include at least one pixel of neighboring pixels adjacent to the prediction block and previously encoded pixels within the prediction block.

In the intra-prediction method, a mode dependent intra shooting (MDIS) filter may be applied to the reference pixels according to the intra-prediction mode, thereby generating a prediction block. Different types of the MDIS filters may be applied to the reference pixels. The MDIS filer is an additional filter applied to an intra-predicted prediction block generated through the intra-prediction. The MDIS filter is used to reduce a residual between the reference pixel and the pixel in the intra-predicted prediction block generated through the prediction. When performing the MDIS filtering, different filtering may be applied to the reference pixel and several columns in the intra-predicted prediction block in accordance with directions of the intra-prediction modes.

The inter-prediction module 422 may perform prediction by referring to information of blocks included within at least one of a previous picture and a subsequent picture of a current picture. The inter-prediction module 422 may include a reference picture interpolation module, a motion prediction module, and a motion compensation module.

The reference picture interpolation module may be provided with reference picture information by the memory 495 and may generate pixel information of less than an integer pixel from a reference picture. In the case of luma pixels, a DCT-based 8-tap interpolation filter having a varying filter coefficient may be used to generate pixel information of less than an integer pixel in a unit of ¼ pixel. In the case of chroma pixels, a DCT-based 4-tap interpolation filter having a varying filer coefficient may be used to generate pixel information of less than an integer pixel in a unit of ⅛.

The intra-prediction module 422 may perform motion prediction based on a reference picture that is interpolated by the reference picture interpolation module. Various methods, such as a full-search based matching algorithm (FBMA), a three step search (TSS), a new three-step search (NTS) algorithm, may be used to calculate a motion vector. A motion vector has a motion vector value in a unit of ½ or ¼ pixel on the basis of an interpolated pixel. The inter-prediction module 122 and 127 may predict a prediction block of a current block using one inter-prediction mode selected among various inter-prediction modes.

As the inter-prediction method, various methods such as a skip method, a merge method, and a method using a motion vector predictor (MVP) may be used.

In the inter-prediction, motion information such as a reference index, a motion vector, and a residual signal may be entropy-encoded and then transmitted to the decoder. When the skip mode is applied, a residual signal is not generated, so that transform and quantization on a residual signal may be omitted.

A residual block including residual information that is a difference value between a prediction block generated by the prediction module 420 and a reconstructed block of the prediction block may be generated, and the residual block may be input to the transform module 430.

The transform module 430 may transform the residual block by using a transform method such as a discrete cosine transform (DCT) or a discrete sine transform (DST). A transform method to be used to transform the residual block may be determined among the DCT and the DST on the basis of the intra prediction mode information of the prediction unit used to generate the residual block, and the size information of the prediction block. That is, the transform module 430 may differently transform the residual block in accordance with the size of the prediction block and the prediction method.

The quantization module 440 may quantize values transformed into a frequency domain by the transform module 430. A quantization coefficient may change depending on a block or importance of an image. Values output from the quantization module 440 may be supplied to the dequantization module 470 and the rearrangement module 450.

The rearrangement module 450 may rearrange coefficients with respect to the quantized residual values. The rearrangement module 450 may change two-dimensional block type coefficients to one-dimensional vector type coefficients through coefficient scanning. For example, the rearrangement module 450 may change two-dimensional block type coefficients to one-dimensional vector type coefficients by scanning from DC coefficients to coefficients of a high frequency domain using zigzag scanning. Vertical scanning of scanning two-dimensional block type coefficients in a column direction and horizontal scanning of scanning two-dimensional block type coefficients in a row direction may be used depending on a size of a transform block and an intra-prediction mode, instead of zigzag scanning. That is, a scanning method for use may be selected based on the size of a transform block and the intra prediction mode among zigzag scanning, vertical scanning, and horizontal scanning.

The entropy encoding module 460 may perform entropy encoding on the basis of the values obtained by the rearrangement module 450. Various encoding methods, such as exponential Golomb, context-adaptive variable length coding (CAVLC), and context-adaptive binary arithmetic coding (CABAC), may be used for entropy encoding.

The entropy encoding module 460 may encode a variety of information, such as residual coefficient information and block type information on a coding block, prediction mode information, partitioning unit information, prediction block information, transfer unit information, motion vector information, reference frame information, block interpolation information, and filtering information, all of which are provided by the rearrangement module 450 and the prediction module 420. The entropy encoding module 460 may entropy-encode coefficients of a coding unit input from the rearrangement module 450.

The entropy encoding module 460 may encode intra-prediction mode information of a current block by performing binarization on the intra-prediction mode information. The entropy encoding module 460 may include a codeword mapping module for performing the binarization and may perform the binarization in a different way according to a size of a prediction target block for intra-prediction. A codeword mapping table may be adaptively generated through the binarization by the codeword mapping module or may be preliminarily stored in the codeword mapping module. According to another embodiment, the entropy encoding module 460 may represent current prediction mode information by using a codeNum mapping module for performing codeNum mapping and the codeword mapping module for performing codeword mapping. The codeNum mapping module and the codeword mapping module may respectively have a codeNum mapping table and a codeword table that are preliminarily stored or generated later.

The dequantization module 470 inversely quantizes the values quantized by the quantization module 440 and the inverse transform module 480 inversely transforms the values transformed by the transform module 430. The residual values generated by the dequantization module 470 and the inverse transform module 480 may be added to the prediction block, which is predicted by the motion vector prediction module, the motion compensation module, and the intra-prediction module of the prediction module 420, thereby generating a reconstructed block.

The filter module 490 may include at least one of a deblocking filter and an offset correction module.

The deblocking filter may remove block distortion generated on boundaries between blocks in the reconstructed picture. Whether to apply the deblocking filter to a current block may be determined on the basis of pixels included in several rows or columns of the block. When the deblocking filter is applied to a block, a strong filter or a weak filter may be applied depending on a required deblocking filtering strength. When horizontal filtering and vertical filtering are performed in applying the deblocking filter, horizontal filtering and vertical filtering may be performed in parallel.

The offset correction module may correct an offset of the deblocked picture from the original picture pixel by pixel. A method of partitioning pixels of a picture into a predetermined number of regions, determining a region to be subjected to offset correction, and applying offset correction to the determined region or a method of applying offset correction in consideration of edge information of each pixel may be used to perform offset correction on a specific picture.

The filter module 490 may apply neither the deblocking filter nor the offset correction, may apply only the deblocking filter, or may apply both of the deblocking filter and the offset correction.

The memory 495 may store the reconstructed block or picture output from the filter module 490, and the stored reconstructed block or picture may be supplied to the prediction module 420 when performing inter-prediction.

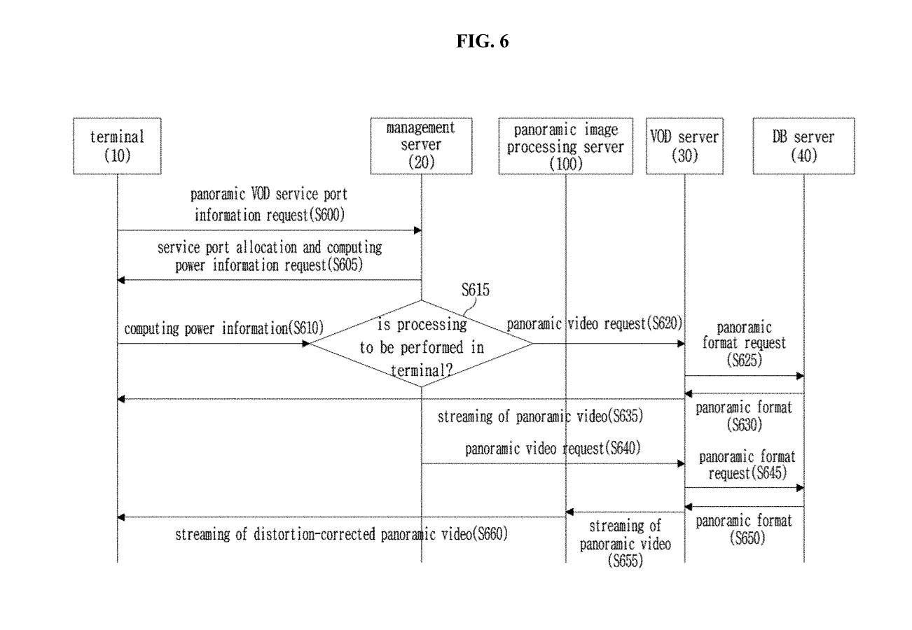

FIG. 6 is an application example of the present invention and illustrates a system for performing de-warping based on computing power.

Referring to FIG. 6, a terminal 10 requests service port information with respect to a panoramic VOD from a management server 20 (Step S600).

When the terminal 10 requests the service port information, the management server 20 transmits the service port information to the terminal 10 and requests computing power information from the terminal 10 (Step S605).

In response to the request of the management server 20, the terminal 10 transmits the computing power information thereof to the management server 20 (Step S610).

The management server 20 may determine whether to perform a process of de-warping an input image in the server 10, based on the computing power information received from the terminal 10 (Step S615).

When it is determined that the de-warping on the input image is to be performed in the terminal 10, the management server 20 requests a panoramic video from a VOD server 30 (Step S620).

When the management server 20 requests the panoramic video, the VOD server 30 requests a panoramic format from a DB server 40 (Step S625). In response to the request of the VOD server 30, the DB server 40 may transmit a panoramic format to the VOD server 30 (Step S630). The VOD server 30 may transmit a panoramic video stream corresponding to the panoramic format informed by the DB server 40, to the terminal 10 (Step S635).

The terminal 10 may reconstruct a warped image by decoding the received panoramic video stream, perform de-warping on the warped image, and encode the de-warped image again. To this end, the terminal 10 includes a warped region determination module 200, a de-warping module 300, and an encoder 400 like the panoramic image processing server 100. Since this configuration has been described above with reference to FIG. 4, a further description thereabout will not be given here.

When it is determined that de-warping on the input image is to be performed in the panoramic image processing server 100, the management server 20 requests a panoramic video from the VOD server 30 (Step S640).

When the management server 20 requests the panoramic video, the VOD server 30 may request a panoramic format from the DB server 40 (Step S645), and the DB server 40 may provide the panoramic format to the VOD server 30 in response to the request of the VOD server 30 (Step S650). The VOD server 30 may transmit a panoramic video stream corresponding to the panoramic format provided by the DB server 40 to the panoramic image processing server 100 (Step S655).

The panoramic image processing server 100 may generate a warped image by decoding the received panoramic video stream and perform de-warping on the warped image. The panoramic image processing server 100 may generate a distortion-free panoramic video stream by encoding the de-warped image. Since the de-warping method performed in the panoramic image processing server 100 has been described above in detail with reference to FIG. 4, a further description thereabout will not be given here.

The panoramic video stream generated by the panoramic image processing server 100 may be transmitted to the terminal 10 (Step S660). The terminal 10 may decode the received panoramic video and reconstruct distortion-free image information.

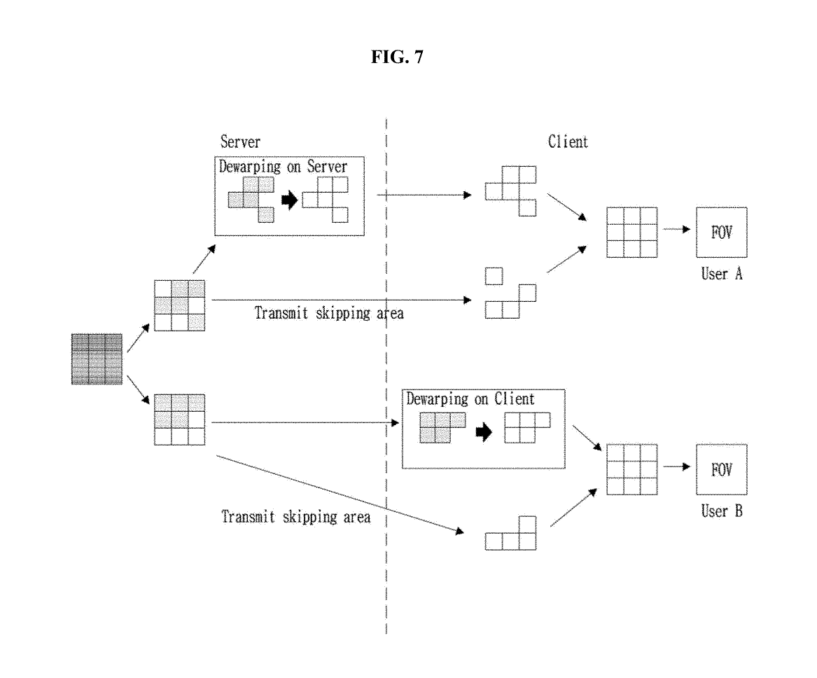

FIG. 7 is an application example of the present invention and illustrates a selective de-warping method in which de-warping is selectively performed in the panoramic image processing server 100 or the terminal 10, depending on the performance of the terminal.

When many users, for example, user A and user B, want to watch the same video, the degree of distortion of each segment may vary depending on the field of view of each user.

Referring to FIG. 7, warped regions within a panoramic video vary according to the field of view (FOV) of each user. In which to perform de-warping on the warped region, the panoramic image processing server 100 or each user terminal, may be determined in consideration of the performance of each user terminal.

For example, when the terminal of the user A has low performance, de-warping on the warped region may be performed in the panoramic image processing server 100, and un-warped regions may not be transmitted to the panoramic image processing server 100 but be directly transmitted to the terminal of the user A. The regions that are de-warped by the panoramic image processing server 100 may be transmitted to the terminal, and the de-warped regions and the un-warped regions are combined and then encoded.

Meanwhile, when the terminal of the user B has high performance, all of the warped regions and the un-warped regions are transmitted to the terminal and then de-warping on the warped regions may be performed in the terminal of the user B. Then, the terminal of the user B may reconstruct the input image by combining the de-warped regions and the un-warped regions and then encode the reconstructed input image.

FIG. 8 is an application example of the present invention and illustrates a process of de-warping a warped region based on quad-tree partitioning.

Whether a current segment is a warped region or an un-warped region may be determined based on at least one of the number of vertices or the shape of a warping mesh within a current segment. Since this determination method has been described above in detail with reference to FIG. 3, a further description thereof will not be given here.

When it is determined that a current segment is a warped region, the current segment may be divided into a plurality of partitions based on quad-tree structure partitioning, and it is further determined whether each of the partitions constituting the current segment is a warped region or an un-warped region by using the method of FIG. 3. The quad-tree structure partitioning is used to precisely detect warped regions within the current segment. The quad-tree structure partitioning used in the present invention will be described with reference to FIG. 9. Meanwhile, when the current segment is determined as being an un-warped region, it means that no distorted image information exists within the current segment. In this case, the quad-tree structure partitioning is not performed.

Specifically, the current segment may be divided into four partitions (i.e., partitions 0 to 3) based on the quad-tree structure partitioning. Whether each of the four partitions is a warped region or an un-warped region may be determined, partition by partition, through the method illustrated in FIG. 3. At least one partition among the four partitions may be determined as being a warped region. For example, the partition 0 may be determined as being a warped region, and the other partitions 1 to 3 may be determined as being un-warped regions. In this case, the partition 0 determined as being a warped region is further divided based on the quad-tree structure partitioning, and then whether each of the divided partitions (hereinafter, referred to as sub-partitions) constituting the partition 0 is a warped region or an un-warped region may be determined.

When a partial region (for example, a segment, a partition, or a sub-partition) of a panoramic image is determined as being an warped region through the process described above, a split depth or a split level is increased and the partial region is divided into four pieces. In this way, it is possible to precisely detect the location of the warped region existing in the panoramic image. The quad-tree structure partitioning may be performed only within a range of a predetermined split depth and/or a predetermined block size. The predetermined split depth may mean a maximum split depth and the predetermined block size may mean a minimum block size up to which partitioning is allowed. The predetermined split depth and the predetermined block size may be fixed values preset in the panoramic image processing server or variable values set by a user.

FIG. 9 is an application example of the present invention and illustrates a method of dividing a segment based on a quad-tree structure.

In FIG. 9, it is assumed that a segment 900 has a split level of 0 and is a warped region. The segment may be divided into four partitions (i.e., partitions 0, 1, 2, and 3). In this case, the split level of each partition is increased to 1, and then it is determined whether each partition is a warped region or an un-warped region.

When the partition 0 is determined as being a warped region, as illustrated in FIG. 9, the partition 0 is divided into four sub-partitions including sub-partitions a to d. Since the partition 1 and the partition 2 are un-warped regions, the partitions 1 and 2 are not further divided.

The partition 3 is determined as being a warped region. As illustrated in FIG. 9, the partition 3 is divided into four sub-partitions, and the split level of each sub-partition is increased to 2. Next, it is determined whether each of the four sub-partitions is a warped region or an un-warped region.

Sub-partitions g, l, and m included in the partition 3 are determined as being un-warped regions and thus are not further split. Meanwhile, a sub-partition consisting of blocks h to k is a warped region. Therefore, this sub-partition is further divided into the four blocks h to k, and the split level of each block is increased to 3. When the preset maximum split level is 3 or when the bock size of the four blocks h to k is equal to a minimum block size up to which block partitioning is allowed, a determination of whether each of the blocks h to k is a warped region or an un-warped region may not be performed, and quad-tree structure partitioning may not be further performed.

As described above, it is possible to divide a panoramic image into a warped region and an un-warped region through quad-tree partitioning.

### INDUSTRIAL APPLICABILITY

The present invention may be used to encode and/or decode a panoramic video.

1. A method of encoding a panoramic video, the method comprising:
dividing an input image into a plurality of segments, the segment being a predetermined unit defined for parallel processing of the input image;
determining whether each of the segments is a warped region or an un-warped region, the warped region being a region required to undergo de-warping;
performing the de-warping on a segment determined as being the warped region, based on a panoramic format associated with the input image, thereby producing a de-warped segment; and
encoding the de-warped segment.

2. The method according to claim 1, wherein the determining whether each of the segments is a warped region or an un-warped region is performed based on at least one of the number of vertices of a warping mesh within the segment or a shape of the warping mesh.

3. The method according to claim 1, wherein the panoramic format means a warping type or an image distortion pattern associated with the input image.

4. The method according to claim 3, wherein the performing the de-warping comprises determining the panoramic format, based on camera identification information associated with the input image, and the camera identification information means information signaled to identify a type or a characteristic of a camera used to take the input image.

5. The method according to claim 3, wherein the performing the de-warping comprises:
determining a camera type associated with the input image, based on the camera identification information; and
deriving the panoramic format corresponding to the determined camera type from predefined table information,
wherein the table information includes one or more available panoramic formats for each camera type.

6. The method according to claim 1, wherein the segment includes a plurality of largest coding unit (LCU) rows,
the plurality of LCU rows of the segment undergoes the de-warping in parallel, row by row,
a plurality of LCUs within one LCU row of the plurality of LCU rows sequentially undergoes the de-warping, LCU by LCU, in a predefined scanning order.

7. A device for encoding a panoramic video, the device comprising:
a warped region determination module configured to divide an input image into a plurality of segments and to determine whether each of the segments is a warped region or an un-warped region, the segment meaning a predetermined unit defined for parallel processing of the input image, the warped region meaning a region required to undergo de-warping;
a de-warping module configured to perform the de-warping on a segment determined as being the warped region, based on a panoramic format of the input image, thereby generating a de-warped segment; and
an encoder configured to encode the de-warped segment.

8. The device according to claim 7, wherein the warped region determination module determines whether each of the segments is the warped region or the un-warped region, based on at least one of the number of vertices of a warping mesh within the segment or a shape of the warping mesh.

9. The device according to claim 7, wherein the panoramic format means a warping type or an image distortion pattern associated with the input image.

10. The device according to claim 9, wherein the de-warping module determines the panoramic format, based on camera identification information associated with the input image,
the camera identification information means information signaled to identify a type or a characteristic of a camera used to take the input image.

11. The device according to claim 9, wherein the de-warping module determines a camera type associated with the input camera, based on the camera identification information, and derives the panoramic format corresponding to the determined camera type from predefined table information, and
the table information includes one or more available panoramic formats for each camera type.

12. The device according to claim 7, wherein the segment includes a plurality of largest coding unit (LCU) rows,
the de-warping module performs the de-warping in parallel on the LCU rows included in the segment, row by row, and
a plurality of LCUs included in one LCU row of the plurality of LCU rows sequentially undergoes the de-warping, LCU by LCU, in a predefined scanning order.

13. A system for encoding a panoramic video, the system comprising:
a panoramic image processing server configured to determine whether each of a plurality of segments constituting a panoramic video is a warped region or an un-warped region, perform de-warping on a segment determined as being the warped region, based on a panoramic format associated with the panoramic video, and encode the de-warped segment, the segment meaning a predetermined unit defined for parallel processing of the input image, the warped region meaning a region required to undergo the de-warping; and
a database server configured to determine a panoramic format associated with the panoramic video.

14. The system according to claim 13, wherein the database server determines a panoramic format to be used for the de-warping of the panoramic video, based on camera identification information associated with the input image, and informs the panoramic image processing server of the determined panoramic format.

15. The system according to claim 14, wherein the database server determines a type of a camera used to take the panoramic video based on the camera identification information, and derives a panoramic format corresponding to the determined camera type from predefined table information, wherein the table information includes one or more available panoramic formats for each camera type.
